(19) United States
(12) Patent Application Publication
(10) Pub. No.: US 2004/0172323 A1
(43) Pub. Date: Sep. 2, 2004

(54) Customer feedback method and system

(75) Inventor: Patrick Stamm, Duluth, GA (US)

Correspondence Address: MERCHANT & GOULD PC, P.O. BOX 2903, MINNEAPOLIS, MN, 55402-0903, US

(73) Assignee: BellSouth Intellectual Property Corporation

(21) Appl. No.: 10/643,353

(22) Filed: Aug. 19, 2003

Related U.S. Application Data
(60) Provisional application No. 60/450,641, filed on Feb. 28, 2003.

(51) Int. Cl. G06F 17/60

(52) U.S. Cl. 705/10

(57) ABSTRACT

An improved customer feedback method and system are provided. A customer feedback survey process is conducted whereby a customer-sampling group is identified. A set of survey questions is constructed relative to the selected sampling group. Contact information for customers or consumers comprising the sampling group is obtained. Customers or consumers comprising the sampling group are contacted. Collected feedback information is stored in a feedback information database. Reports summarizing the colleted feedback information may be forwarded to supervisory personnel or may be posted to an Internet-based website. An employee performance scorecard is prepared. Performance scores, feedback comments and coaching comments tailored for particular performance may be provided on the scorecard for each category of performance.

### CROSS REFERENCE TO RELATED APPLICATIONS

The present application claims priority from U.S. provisional application No. 60/450,641 entitled “Customer Feedback Process,” filed Feb. 28, 2003, said application incorporated herein by reference.

### FIELD OF INVENTION

The present invention relates to methods and systems for aggregating and reporting customer feedback information.

### BACKGROUND OF INVENTION

Customer feedback methods and systems allow a variety of goods and services providers, such as business operators and professional services providers to receive solicited and unsolicited feedback from customers, patrons, product users and others to help such goods and services providers to improve performance, services rendering, product quality, employee training and the like. Many large services providers employ hundreds or even thousands of employees such as technicians and representatives who frequently communicate with and provide goods and/or services to like numbers of consumers. Many such services providers conduct customer surveys to inquire as to the performance of their employees. Unfortunately, such surveys typically take days or weeks to compile, and feedback information may only be provided to employees after extended periods of time such as once per month or longer. And, often such surveys net only general positive or negative feedback and very little specific information with which a supervisor may counsel or coach his or her employees. Moreover, information gathered from such systems often results in varying interpretations where one supervisor may interpret feedback information one way, while another supervisor may interpret the same feedback information in an inconsistent manner. The frequency and timeliness of such feedback information is also problematic because of the likelihood that a given employee may receive negative feedback for poor performance of the employee weeks ago, even though the employee has since dramatically improved his or her performance. Or, the employee may receive a rave review today based on great performance weeks ago, even though the employee's performance has since dramatically declined.

Accordingly, there is a need for an improved customer or consumer feedback method and system that provides frequent, timely and relevant feedback and that provides for consistent supervisory review. It is with respect to these and other considerations that the present invention has been made.

### SUMMARY OF THE INVENTION

Embodiments of the present invention solve the above and other problems by providing an improved customer feedback method and system. Generally described, a customer feedback survey process is conducted whereby a customer-sampling group is identified. A set of survey questions is constructed relative to the selected survey-sampling group. Contact information for customers or consumers comprising the sampling group is obtained. Customers or consumers comprising the sampling group are contacted by live telephone communication, computer-controlled interactive voice response communication, or customer or consumers may be contacted electronically and may be directed to an online survey session. Customers or consumers may initiate a survey at a survey station such as a survey kiosk.

After feedback information is collected from the customers or consumers comprising the sampling group, collected information is stored in a feedback information database. Reports summarizing the colleted feedback information may be forwarded to supervisory personnel or may be posted to an Internet-based website.

After feedback information is collected and stored, the information is analyzed. Performance scores and feedback comments are assembled for each individual employee for whom a survey was conducted. Scores and feedback comments may be prepared for performance periods such as daily, weekly, or monthly. A comparison analysis may be performed comparing performance scores and feedback comments for a given employee to past performance scores and feedback comments for the same employee. Also, performance scores and feedback comments for a given employee may be compared to scores and comments for a group of employees.

After analysis is complete, an employee performance scorecard is prepared. Performance scores and feedback comments may be provided on the scorecard for each category of performance. Also, for each category of performance, a coaching comment may be provided for use by the employee's supervisor for counseling and coaching the employee regarding his or her individual and/or comparative performance.

According to one aspect of the invention, coaching comments are tailored for the employee based on the performance score and feedback comments associated with a given category of performance. A scorecard database includes a variety of different coaching comments for a variety of different performance scores and feedback comments. The scorecard database may be queried with feedback analysis information associated with a given employee and associated with a particular performance category. Coaching comments associated with performance scores and feedback comments for a particular performance category are retuned from the database in response to the database query, and the coaching comments are populated onto the performance scorecard under the performance category with which each coaching comment is associated.

These and other features and advantages, which characterize the present invention, will be apparent from a reading of the detailed description and a review of the associated drawings. It is to be understood that both the foregoing general description and the following detailed description are exemplary and explanatory only and are not restrictive of the invention as claimed.

### BRIEF DESCRIPTION OF THE DRAWINGS

FIG. 1 is a simplified diagram showing an exemplary operating architecture for a customer feedback method and system of the present invention.

FIG. 2 is a simplified diagram illustrating the collection, analysis and reporting of customer feedback information according to an embodiment of the present invention.

FIG. 3 illustrates an example set of survey questions for obtaining customer feedback information according to an embodiment of the present invention.

FIG. 4 is a flow diagram showing an illustrative routine for collecting customer or consumer feedback information according to an embodiment of the present invention.

FIG. 5 is a flow diagram illustrating an illustrative routine for analyzing customer feedback information for a given employee and for preparing a performance scorecard for a given employee according to an embodiment of the present invention.

FIG. 6 illustrates an example employee performance scorecard according to an embodiment of the present invention.

### DETAILED DESCRIPTION

As described briefly above, embodiments of the present invention are directed to methods and systems for collecting, analyzing, and reporting customer feedback information. In the following detailed description, references are made to the accompanying drawings that form a part hereof, and in which are shown illustrations, specific embodiments or examples. These embodiments may be combined, other embodiments may be utilized, and structural changes may be made without departing from the spirit or scope of the present invention. The following detailed description is therefore not to be taken in a limiting sense, and the scope of the present invention is defined by the appended claims and their equivalents.

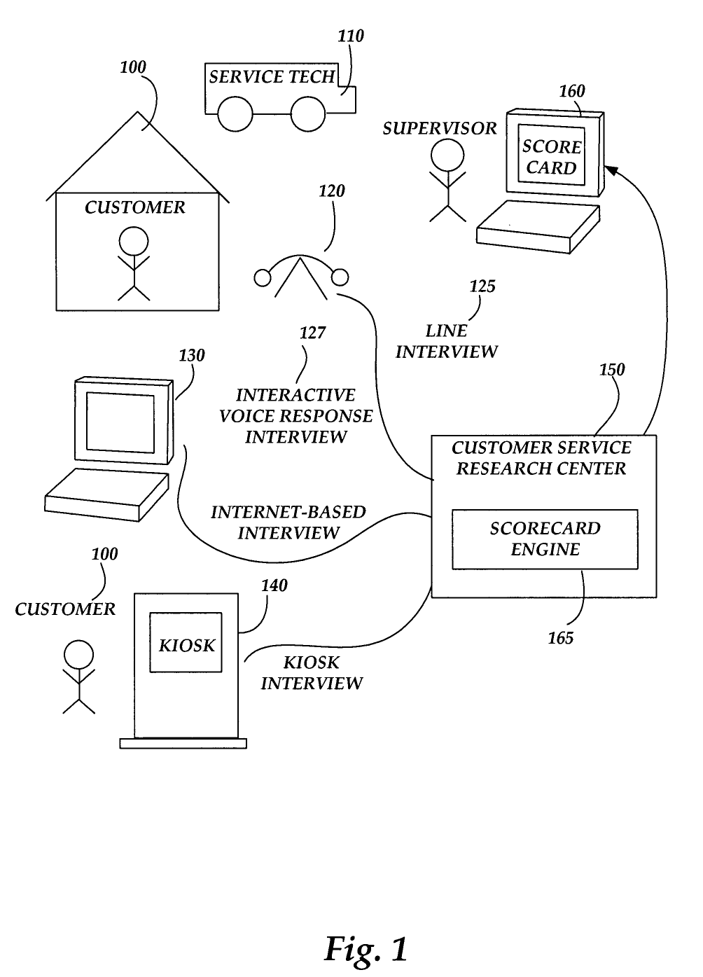

FIG. 1 is a simplified diagram showing an exemplary operating architecture for a customer feedback method and system of the present invention. According to an embodiments of the present invention, an employer, business operator, service provided or the like may collect, analyze, and report customer feedback information on employees, service technicians, products, or services. For example, a large telecommunications system may send hundreds or even thousands of services technicians to a like number of residences, businesses, educational institutions, and the like to install or maintain telecommunications systems. According to embodiments of the present invention, such a company may survey customers as to the performance attributes of one or more service technicians who are tasked with providing a required service or product to a given customer. Survey information gathered through the survey process is analyzed for each associated employee, and an employee scorecard is prepared containing performance scores and feedback comments and containing employee coaching comments for use by a given employees's supervisor.

Referring to FIG. 1, a customer service research center 150 is provided from which customer surveys are conducted. As will be described in further detail below, at the customer service research center, customer sampling information is obtained including a list of customers to be surveyed, and contact information for each customer to be surveyed. The customer service center 150 may then conduct a customer service survey for a given customer 100 by posing a list of prepared questions to the customer 100 to obtain information regarding various performance categories. For example, questions may solicit information regarding a given employee's timeliness, skills, attitude, helpfulness, personal appearance, and the like.

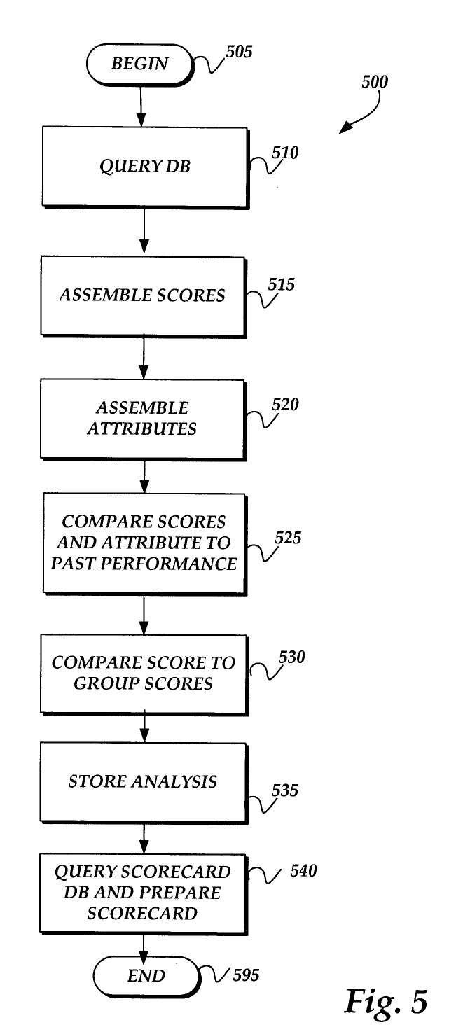

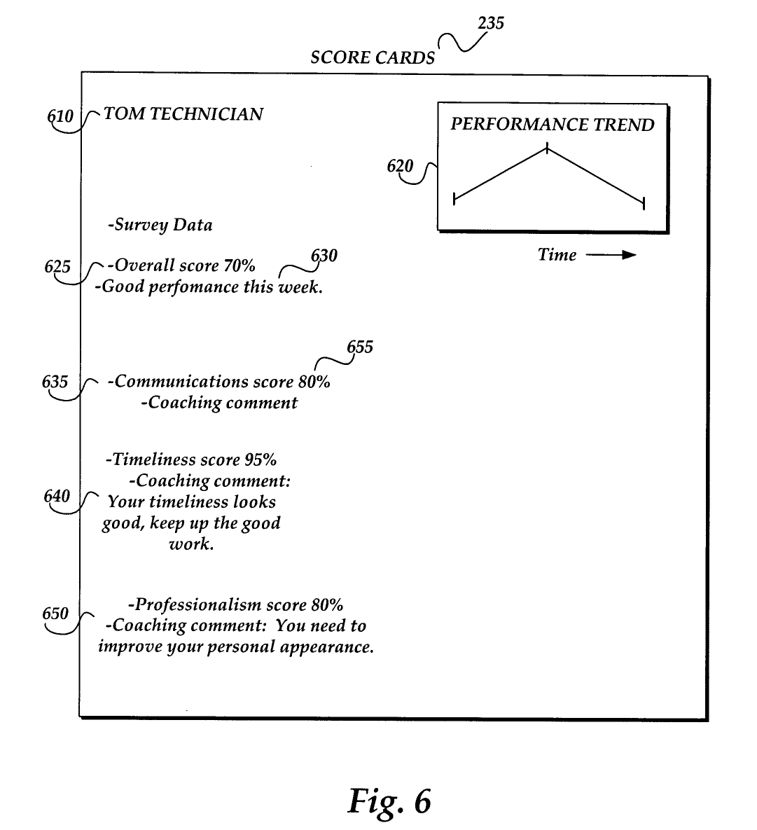

The scorecard engine 165 illustrates a software application program or collection of software application programs each containing or in combination containing sufficient computer executable instructions which when executed by a computer perform the functionality of collecting, analyzing and reporting survey results as described herein. As will be described below with reference to FIGS. 5 and 6, the scorecard engine 165 also is operable to create a performance scorecard by combining aggregated and analyzed performance information and by extracting coaching comments for population into a performance scorecard in association with given performance scores and other performance attributes related to performance categories.

According to embodiments of the present invention, a given customer 100 may be contacted telephonically via the customer's wireless or wireline telephone 120 through which a live interview 125 may be conducted between personnel of the customer service research center and the customer 100. Alternatively, an interactive voice response interview 127 may be conducted whereby the customer 100 is contacted by a computer-controlled interactive voice response system. According to an interactive voice response system (IVR), the customer 100 is provided text-to-speech questions to which the customer may respond. The interactive voice response system collects answers from the customer by DTMF key tone selection from the customer or by speech recognition of responses provided by the customer.

According to another embodiment, an Internet-based interview may be conducted to obtain customer feedback information from a given customer 100. The customer 100 may be contacted by electronic mail from the customer service center 150. The electronic mail message to the customer may provide a link to an Internet-based survey site where the customer is requested to complete a web-based survey form. Alternatively, the customer 100 may visit a survey station such as a kiosk 140 that may be maintained on the premises of the employee's company. The customer 100 may complete and submit a feedback survey form on the kiosk 140 in a manner similar to completion of the web-based survey form, described above.

As will be described in detail below, results of the customer service survey performed by the customer service research center 150 may be stored and analyzed. A report of the obtained survey results will be forwarded to the employee's supervisor through a variety of means including posting the report results to a web-based posting site on the supervisor's computer 160. After survey results for a given employee are obtained and analyzed, an employee performance scorecard is prepared and forwarded to the employee's supervisor.

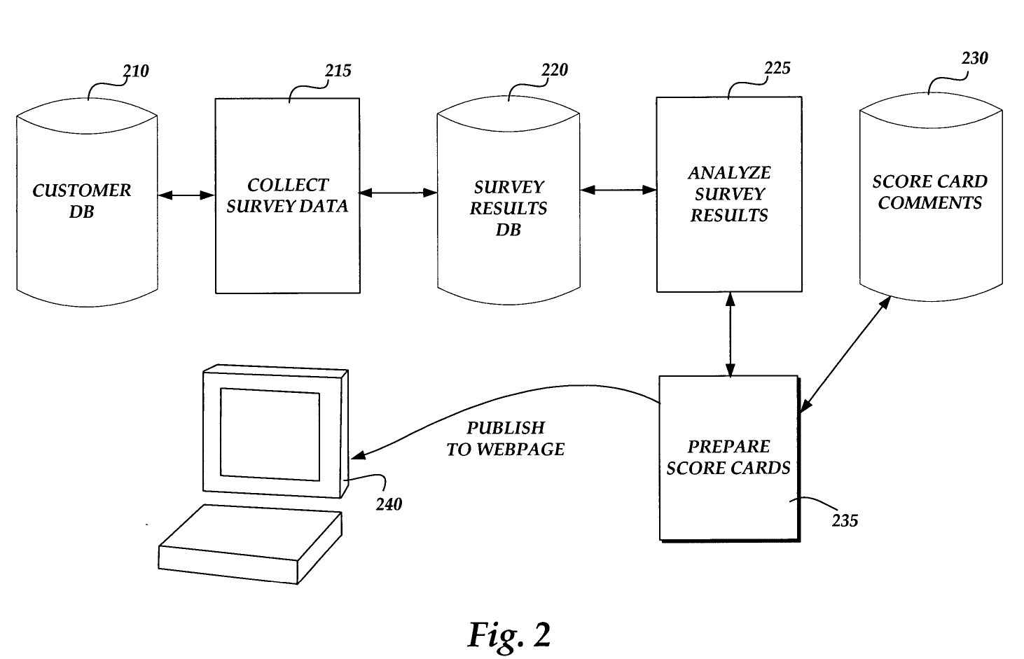

FIG. 2 is a simplified diagram illustrating the collection, analysis and reporting of customer feedback information according to an embodiment of the present invention. The customer feedback system of the present invention preferably includes a customer feedback data collection component 215, a survey results analysis component 225, and an employee performance scorecard preparation component 235. Referring to FIG. 2, a customer database 210 is illustrated for containing information on one or more customers for whom a service has been provided or to whom products have been sold by a given company business or other entity. Prior to commencing a customer feedback survey, the customer database 210 is queried to obtain all customer names and contact information associated with a given survey. For example a customer-sampling group might include all customers for whom telephone service has been provided during the past 24-hour period. After survey data is collected from one or more customers comprising the survey sampling group, collected data is stored in a survey results database 220. If desired, raw survey results may be compiled and forwarded to supervisors for employees for whom survey results have been collected.

According to embodiments of the present invention, survey results are extracted from the survey results database 220 and are analyzed for each individual employee. After analysis of survey results for a given employee, an employee performance scorecard is prepared. A scorecard comments database 230 is queried for coaching comments associated with performance scores and feedback comments associated with particular performance categories. After a given employee performance scorecard is prepared, as described in detail below, the scorecard is forwarded to the employee's supervisor. According to one embodiment of the present invention, the scorecard is published to an Internet-based or intranet-based web page for review by a given employee's supervisor.

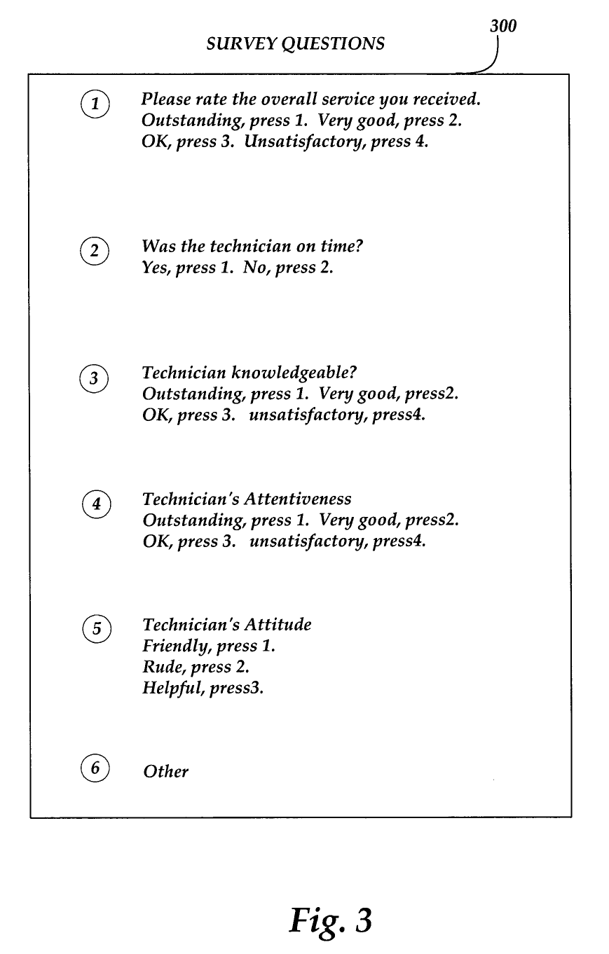

As briefly described above, during the customer survey process, a set of survey questions are identified for directing to customers or consumers comprising the survey-sampling group. FIG. 3 illustrates an example set of survey questions for obtaining customer feedback information according to an embodiment of the present invention. The list of survey questions illustrated in FIG. 3 is by way of example only and is not to be taken as limiting of the invention described herein. As described above, the list of survey questions may be directed to a customer or consumer by a live telephone interviewer, by interactive voice response system, via an Internet-based web page or via an alternative survey mechanism such as a survey kiosk.

As illustrated in FIG. 3, a first question may be posed such as “please rate the overall service you received.” If the questions are presented to the survey participant via a live interview, the participant's response may be logged by the live interviewer. However, if the survey is being conducted through an IVR session, the participant may respond to survey questions through DTMF keypad selection, or the participant may respond by voice interaction with the interactive voice response system. If the participant responds to the questions via an Internet-based or kiosk-based survey form, the participant may select the appropriate responses on the form.

As illustrated in FIG. 3, a variety of different performance categories may be directed to a customer or consumer participant in the survey. Performance categories may be tailored depending upon type of service or product about which the survey is conducted. As illustrated in FIG. 3, performance categories for a given service rendering may include an overall service performance, a timeliness performance, a knowledge performance, an attentiveness performance, an attitude performance, and other. Additionally, a variety of canned feedback comments (not shown) may be provided for each category that may be selected by a survey participant. For example, for the timeliness category, illustrated in FIG. 3, a set of canned feedback comments may be provided for selection by a survey participant. For example, comments such as “the employee arrived ahead of scheduled,” “the employee arrived on time,” “the employee arrived behind schedule,” “the employee failed to notify me that he would be late,” or “the employee called prior to his arrival.” Such canned feedback comments are by way of example only and are not restrictive of the invention as claimed.

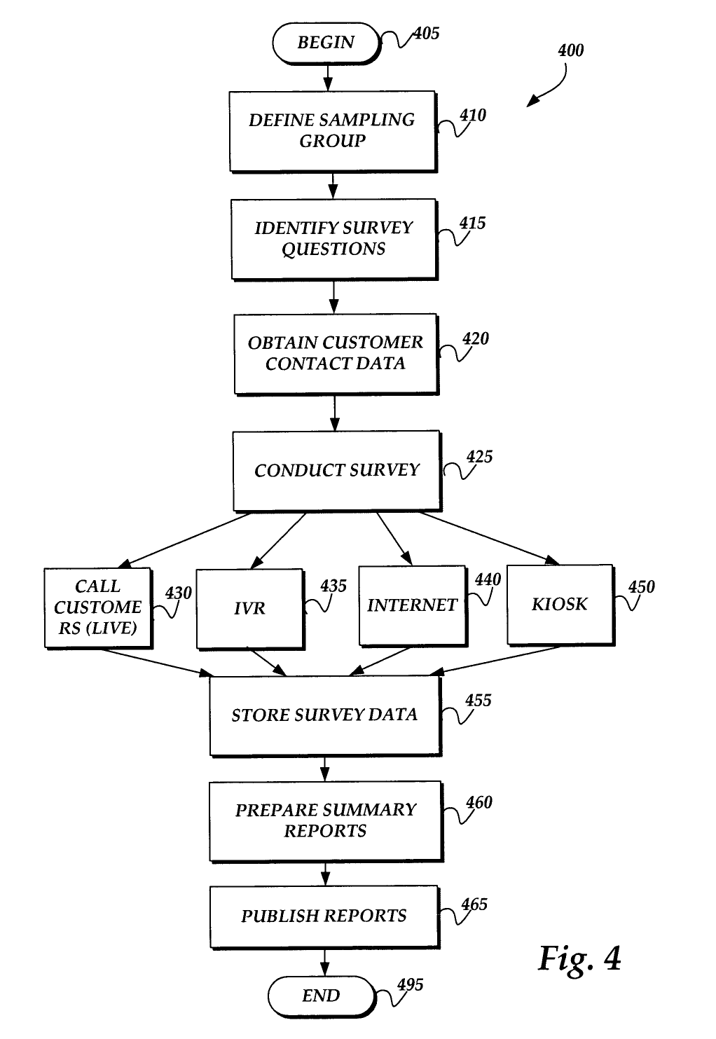

Having described an exemplary system architecture for components of the present invention with respect to FIGS. 1, 2 and 3 above, it is advantageous to describe the process by which customer feedback information is collected according to embodiments of the present invention. FIG. 4 is a flow diagram showing an illustrative routine for collecting customer or consumer feedback information according to an embodiment of the present invention. The method 400 begins at start block 405 and proceeds to block 410 where a sampling group is defined for a given survey. For example, a telecommunications services provider may wish to sample all customers receiving telephone service connection over the past 24 hours. Accordingly, a database query is passed to the customer base 210, described with reference to FIG. 2, and identification information for all customers receiving telephone services connection during the past 24 hour period are extracted from the customer database 210. Along with an identification of the customers to be surveyed, contact information that may be utilized by live telephone interviewer or with which an IVR interview session or Internet-base interview session may be conducted is collected from the customer database 210.

At block 415, survey questions required for the identified sampling group are collected. As should be understood, particular questions comprising the list of survey questions to be directed to survey participants will vary greatly depending upon the service or product for which the survey is conducted. For example, as described above with reference to FIG. 3, an example set of survey questions for surveying the performance of a telephone services technician may include categories covering the overall service performance of the technician, the timeliness of the technician, the knowledge of the technician, the attentiveness of the technician, the attitude of the technician, and the like.

At block 420, customer contact data, as described above, is passed to live survey interviewers, or is populated into an interactive voice response system or Internet-based survey system. According to an embodiment of the present invention, an IVR survey system may automatically dial identified survey participants in order to initiate an IVR survey session. An Internet-based survey session may be initiated by electronically mailing each identified survey participant.

At block 425, the survey is conducted, as described. If the survey is conducted by live telephone interview, the method proceeds to block 430, and each customer comprising the sampling group is contacted by a live interviewer. If the survey is conducted by interactive voice response, the method proceeds to block 435, and the interactive voice response system commences contacting each identified survey participant. If an Internet-based survey session is selected, each survey participant is electronically mailed at block 440 to provide the survey participant a link to a web-based survey form. Or, at block 450, a given survey participant may be invited to enter survey results at a survey kiosk or other automated or live interview system initiated by the customer (survey participant).

At block 455, response to survey questions by each surveyed customer or consumer are collected and are stored in the survey results database 220, as described above with reference to FIG. 2. At block 460, prior to analysis of any data obtained through the survey process, raw data may be summarized in a report, and at block 465, the summary report may be forwarded to supervisory personnel or may be published via an Internet-based or intranet-based reports page. The method ends at block 495.

After the survey information is gathered from one or more survey participants, as described above with reference to FIG. 4, the survey information is extracted from the survey results database 220 and is analyzed for the preparation of an employee performance scorecard. FIG. 5 is a flow diagram illustrating an illustrative routine for analyzing customer feedback information for a given employee and for preparing a performance scorecard for a given employee according to an embodiment of the present invention. The method 500 begins at start block 505 and proceeds to block 510 where one or more database queries and procedures are directed to the survey results database 220 to obtain and analyze the survey results data for one or more employees, products, or services for which a given survey was conducted.

At block 515, scores associated with particular performance categories are assembled and calculated. For example, referring back to the list of questions described above with reference to FIG. 3, an employee may have received a score of outstanding for three out of five service renderings. The employee may have received a score of good for the remaining two out of five service renderings. Accordingly, at block 515, an overall performance score of 85%, for example, may be calculated for the category of “overall service” for the period including the five surveyed service renderings. As should be appreciated by those skilled in the art, the number of service renderings, products sales and the like for which survey results may be obtained during any given period varies depending upon the type of service rendering, product sale or other surveyed matter involved. For example, a telecommunications services technician may be able to perform five residential telephone connections in a given day. Accordingly, survey results for all five services connections may be obtained to allow the technician to receive a performance report for five different service renderings during a single day.

At block 520, performance, comments and other attributes selected or entered by survey participants are assembled. For example, comments “the employee arrived on time” and “the employee arrived ahead of schedule” may be assembled in association with a performance score for that performance category. At block 525, performance scores and attributes such a feedback comments may be compared to past performance periods. For example, performance scores and attributes for a single day may be compared against performance for a previous day, or scores and attributes for a single week may be compared against performance for a previous week. At block 530, the scores and performance attributes for a given employee may be compared against the scores and attributes associated with a group of employees. For example, the scores associated with a telephone services connection technician may be compared against the scores and performances of all telephone services connection technicians for a given services region and for a given performance period. At block 535, the analysis for each employee, product or service type is stored in the survey results database 220 for preparation of an employee performance scorecard 235.

At block 540, the scorecard engine 165 queries the survey results database 220 for survey results for a given employee, product or service and utilizes the results for each particular category to formulate a database query to the scorecard comments database 230 to obtain coaching comments associated with performance category scores and customer feedback for preparation of the scorecard 235. Referring to FIG. 6, an example scorecard 235 prepared at block 540 is illustrated. The scorecard engine 165 populates the scorecard 235 with the name 610 for the employee, product or service. For example, as should be appreciated by those skilled in the art, a survey may be conducted of purchasers of a given product such as a new type of automobile. Accordingly, the name 610 may comprise the automobile type rather than the name of an employee.

Referring still to FIG. 6, the scorecard engine 165 populates the scorecard with the calculated performance score for each performance category for which survey results were obtained. As shown in FIG. 6, and by way of example only, the employee scorecard shows an overall performance score of 70% for the subject employee. A communications score of 80% is illustrated, a timeliness score of 95% is illustrated, and a professionalism score of 80% is illustrated. As shown in the upper right hand comer of the scorecard 235, the scorecard engine 165 may also prepare a graphical illustration of survey subjects (employee, product, service) performance over a given period of time. Graphical results may also be shown for the performance trend of a group of employees, products or services with which the survey subject has been compared, as described above with reference to block 530.

Advantageously, a coaching comment 630 may be obtained from the scorecard comment database 230 for each performance category. The coaching comment is tailored for each performance category and for the type of performance posted by a given employee, product or service in view of both the performance score for a given category and other performance attributes such as feedback comments for a given performance category and in view of past performance for the same performance category. For example, referring to the timeliness score category illustrated in FIG. 6, and referring to the survey questions described above with reference to FIG. 3, a given employee may have received a timeliness score 95% for service renderings performed during the past week. The employee may have received customer feedback comments concluding that the employee was on time for all but one service rendering. For a previous week performance, the employee may have also received a timeliness score of 95%, but the employee may have received 2negative timeliness feedback comments. As a result of the comparison between the two weeks of performance, a coaching comment such as “it appears your timeliness is improving, keep up the good work” may be presented with the timeliness score of 95.

On the other hand, if the employee received a 95% timeliness score for the two weeks in question, but the employee received one negative feedback comment in the previous week and two negative feedback comments in the present week, a coaching comment may be provided such as “please keep an eye on your timeliness of service renderings.” From the second example, it can be seen that the coaching comment was altered slightly to reflect the downward trend in timeliness performance. Accordingly, even though the timeliness score is identical for both weeks of performance, the feedback comments are utilized by the scorecard engine 165 to prepare tailored coaching comments for an individual employee.

For another example, a professionalism score of 80% may be attributed to one employee, and feedback comments may indicate that the employee had less than adequate personal appearance. For another employee, an identical professionalism score may be associated with a feedback comment indicating that the employee failed to properly identify himself to the customer. While the two different employees may receive identical professionalism scores of 80%, the feedback comments associated with those scores may generate different coaching comments from the scorecard comments database. Accordingly, the scorecard 235 prepared at block 540 not only contains performance scores for a given employee, product or service, but the scorecard contains comparative performance information and tailored coaching comments for use by supervisory personnel. Thus, inconsistent use of survey results information across different supervisory personnel is eliminated.

After the scorecard 235 is prepared, the scorecard may be forwarded to supervisory personnel, or the scorecard may be published to an Internet-based or intranet-based scorecard-reporting page for review by supervisory personnel. If the scorecard is created for an inanimate object such as a product or service, the scorecard may be forwarded to a product or services development team or director. Likewise, the coaching comments attributable to employees, illustrated and described with reference to FIG. 6, may include feedback information related to product offerings or service offerings about which surveys have been conducted. The method illustrated in FIG. 5 ends at block 595.

As described herein, an improved customer, product or service feedback method and system are provided. Advantageously, feedback information may be collected as frequently as desired, and results may be accumulated, analyzed, and reported via a performance scorecard on a frequent and/or periodic basis. The performance scorecard not only contains performance and comparative performance scoring and individual performance feedback information, but the scorecard includes coaching comments that are tailored to the particular performance of a given employee, product or service for which survey results are collected. It will be apparent to those skilled in the art that various modifications or variations may be made in the present invention without departing from the scope or spirit of the invention. Other embodiments of the invention will be apparent to those skilled in the art from consideration of the specification and practice of the invention disclosed herein.

What is claimed is:

1. A method for aggregating and reporting customer feedback information, comprising:
conducting a survey by asking one or more survey questions about one or more performance categories associated with a survey subject to each of one or more survey participants;
collecting responses from each of the one or more survey participants in response to each of the one or more survey questions;
determining performance scores for each of the one or more performance categories;
assembling performance comments for each of the one or more performance categories from each of the one or more survey participants about the performance of the survey subject;
determining a coaching comment for each of the one or more performance categories based on a performance score and assembled performance comments for each of the one or more performance categories; and
preparing a performance survey subject scorecard containing a performance score and coaching comment for each of the one or more performance categories.

2. The method of claim 1, whereby the survey subject scorecard further contains one or more performance comment received from one or more survey participant for each of the one or more performance categories.

3. The method of claim 1, prior to determining performance scores for each of the one or more performance categories, categorizing responses to each of the one or more survey questions by survey subject and by one or more performance categories associated with a the survey subject.

4. The method of claim 3, whereby determining performance scores for each of the one or more performance categories includes analyzing a set of survey responses collected from one or more survey participants responsive to questions about the performance of the survey subject.

5. The method of claim 4, further comprising comparing the performance scores for each of the one or more performance categories with performance scores for the one or more performance categories from a prior survey period.

6. The method of claim 5, further comprising comparing the performance scores for each of the one or more performance categories with performance scores for the one or more performance categories associated with a group of survey subjects.

7. The method of claim 1, further comprising forwarding the survey subject performance scorecard to a survey subject supervisor.

8. The method of claim 7, further comprising posting the survey subject performance scorecard to an Internet-based web page.

9. The method of claim 1, after collecting responses from each of the one or more survey participants in response to each of the one or more survey questions, storing the responses in a survey results database.

10. The method of claim 9, further comprising preparing a summary report for each survey subject containing responses to each of the one or more survey questions from each of the one or more survey participants.

11. The method of claim 10, further comprising forwarding the summary report to the survey subject supervisor.

12. The method of claim 3, prior to categorizing responses to each of the one or more survey questions by survey subject and by one or more performance categories associated with a the survey subject, querying a survey results database for responses for each of the one or more survey participants in response to each of the one or more survey questions.

13. The method of claim 1, prior to determining a coaching comment for each of the one or more performance categories based on a performance score and assembled performance comments for each of the one or more performance categories, querying a coaching comments database for the coaching comments.

14. The method of claim 1, prior to conducting a survey by asking one or more survey questions about one or more performance categories associated with a survey subject to each of one or more survey participants, identifying one or more survey participants.

15. The method of claim 14, whereby identifying one or more survey participants includes identifying a survey sampling group based on the survey subject about which the survey is to be conducted.

16. The method of claim 14, further comprising obtaining contact information for each of the one or more survey participants.

17. The method of claim 1, further comprising conducting the survey by live interview with each of the on or more survey participants.

18. The method of claim 1, further comprising conducting the survey by interactive voice response session with each of the on or more survey participants.

19. The method of claim 1, further comprising conducting the survey by Internet-based interview session with each of the on or more survey participants.

20. The method of claim 1, further comprising conducting the survey via a survey kiosk with each of the on or more survey participants.

21. The method of claim 1, whereby the survey subject is an employee.

22. The method of claim 1, whereby the survey subject is a product.

23. The method of claim 1, whereby the survey subject is a service.

24. A method for creating a customer feedback performance scorecard, comprising:
surveying a group of survey participants regarding the performance of a survey subject in association with one or more performance categories;
collecting responses from each survey participant;
based on survey participant responses, determining performance scores for each of the one or more performance categories;
assembling performance comments for each of the one or more performance categories from each survey participant about the performance of the survey subject;
tailoring a coaching comment for each of the one or more performance categories based on performance scores and assembled performance comments and based on a comparison of performance scores and assembled performance comments with performance scores and assembled performance comments associated with prior surveys; and
preparing a performance survey subject scorecard containing a performance score and coaching comment for each of the one or more performance categories.

25. A system for creating a customer feedback performance scorecard, comprising:
a customer service research center operative
to survey a group of survey participants regarding the performance of a survey subject in association with one or more performance categories;
to collect responses from each survey participant;
a customer feedback performance scorecard engine operative
to determine performance scores for each of the one or more performance categories based on survey participant responses;
to assemble performance comments for each of the one or more performance categories from each survey participant about the performance of the survey subject;
to query a coaching comments database for coaching comments related to performance scores and performance comments;
to tailor a coaching comment for each of the one or more performance categories based on performance scores and assembled performance comments and based on a comparison of performance scores and assembled performance comments with performance scores and assembled performance comments associated with prior surveys; and
to prepare a performance survey subject scorecard containing a performance score and coaching comment for each of the one or more performance categories.
